(19) United States
(12) Patent Application Publication
(10) Pub. No.: US 2025/0060652 A1
(43) Pub. Date: Feb. 20, 2025

(54) IMAGE CAPTURE DEVICE AND ELECTRONIC DEVICE WITH IMAGE CAPTURE

(71) Applicant: GUANGZHOU LUXVISIONS INNOVATION TECHNOLOGY LIMITED, Guangzhou (CN)

(72) Inventors: Cheng-Te Tseng, Guangzhou (CN); Wei-Han Wu, Guangzhou (CN)

(73) Assignee: GUANGZHOU LUXVISIONS INNOVATION TECHNOLOGY LIMITED, Guangzhou (CN)

(21) Appl. No.: 18/641,774

(22) Filed: Apr. 22, 2024

(30) Foreign Application Priority Data
Aug. 15, 2023 (CN) 202311031526.1

(51) Int. Cl. G03B 5/02; G03B 3/10; G03B 5/04; G03B 17/12

(52) U.S. Cl. CPC G03B 5/02; G03B 3/10; G03B 5/04; G03B 17/12; G03B 2205/0046

(57) ABSTRACT

An image capture device includes a fixed focal module, a focus module, an actuation module, and a sensing module. The fixed focal module includes a fixed barrel fixes a fixed lens group, the fixed lens group includes a front fixed lens and a plurality of inner fixed lenses, each lens has an optical effective region, and the optical effective region of the front fixed lens is smallest. The focus module is adjacent to the fixed focal module and includes a focus lens, a focus lens optical axis is aligned with a fixed lens group optical axis. The fixed focal module is fixed on the actuation module; the focus module is located in the actuation module. The actuation module actuates the focus module to move along the focus lens optical axis. A sensing optical axis is aligned with the fixed lens group optical axis and the focus lens optical axis.

### CROSS-REFERENCE TO RELATED APPLICATION

This non-provisional application claims priority under 35 U.S.C. § 119 (a) to patent application No. 202311031526.1 filed in China on Aug. 15, 2023, the entire contents of which are hereby incorporated by reference.

### BACKGROUND

### Technical Field

The present invention relates to an image capture device, and in particular, to an image capture device capable of zooming.

### Related Art

Mobile phones and tablet computers are usually equipped with front-facing lenses. However, compared to a rear-facing lens, the front-facing lens usually has a smaller physical size and more space limitations. For example, if the front-facing lens is too large, a screen size design of the mobile phone may be affected. In view of this, it is difficult to achieve, on the front-facing lens, optical performance and a zooming capability the same as those of the rear-facing lens, and consequently, the front-facing lens can only meet basic requirements such as selfies and video calls.

### SUMMARY

In view of the problems existing in the prior art, the present invention provides an image capture device and an electronic device with image capture, to achieve an objective of achieving a good zoom capability with a smaller-sized screen window.

According to an embodiment, the image capture device includes a fixed focal module, a focus module, an actuation module, and a sensing module. The fixed focal module includes a fixed lens group and a fixed barrel, the fixed lens group includes a front fixed lens and a plurality of inner fixed lenses, the fixed barrel fixes the front fixed lens and the plurality of inner fixed lenses, the front fixed lens and the inner fixed lenses each have an optical effective region, the optical effective region of the front fixed lens is smaller than or equal to the optical effective region of each inner fixed lens, and the fixed lens group has a fixed lens group optical axis. The focus module is adjacent to the fixed focal module and includes a focus lens, the focus lens has a focus lens optical axis, and the focus lens optical axis is aligned with the fixed lens group optical axis. The fixed focal module is fixed on the actuation module, the focus module is located in the actuation module, and the actuation module is configured to actuate the focus module to move along the focus lens optical axis. The sensing module has a sensing optical axis, and the sensing optical axis is aligned with the fixed lens group optical axis and the focus lens optical axis.

In an embodiment, the actuation module includes a housing, an actuator, a connecting member, and a base, the actuator, the connecting member, and the base are located in the housing, the base supports the connecting member, the actuator surrounds the connecting member and the connecting member is in contact with the focus module to enable the actuator to actuate the connecting member, the connecting member moves the focus module along the focus lens optical axis, the housing has a window, and the fixed barrel is fixed to the window.

In an embodiment, the focus module includes a focus barrel, the focus barrel fixes the focus lens, the window corresponds to a contact region between the connecting member and the focus barrel, the actuation module includes a covering layer, the covering layer is located above the window, and the fixed barrel is located on the covering layer. In an embodiment, the sensing module includes a circuit board, a sensor, and a holder, the sensor and the holder are located on the circuit board, and the holder covers the sensor.

The present invention further provides an electronic device with image capture, which includes an input interface, an image capture device, a main board, and a display. The input interface is configured to receive an input instruction. The image capture device is connected to the input interface, and the image capture device includes a fixed focal module, a focus module, an actuation module, and a sensing module. The fixed focal module includes a fixed lens group and a fixed barrel, the fixed lens group includes a front fixed lens and a plurality of inner fixed lenses, the fixed barrel fixes the front fixed lens and the plurality of inner fixed lenses, the front fixed lens and the inner fixed lenses each have an optical effective region, the optical effective region of the front fixed lens is smaller than or equal to the optical effective region of each inner fixed lens, the fixed lens group has a fixed lens group optical axis, and the fixed lens group optical axis corresponds to a target object. The focus module is adjacent to the fixed focal module and includes a focus lens, the focus lens has a focus lens optical axis, and the focus lens optical axis is aligned with the fixed lens group optical axis. The fixed focal module is fixed on the actuation module, the focus module is located in the actuation module, and the actuation module is configured to actuate the focus module to move along the focus lens optical axis. The sensing module has a sensing optical axis, the sensing optical axis is aligned with the fixed lens group optical axis and the focus lens optical axis, and the sensing module is configured to capture the target object according to the input instruction and convert an image of the target object into an image signal. The main board is connected to the image capture device, and the main board receives the image signal from the image capture device. The display is connected to the main board, the display has a translucent region, the front fixed lens is located in the translucent region, and the display receives the image signal through the main board and then displays an image according to the image signal.

### BRIEF DESCRIPTION OF THE DRAWINGS

FIG. 1 is a three-dimensional perspective view of an image capture device according to an embodiment;

FIG. 2 is a cross-sectional view of a section position A-A marked in FIG. 1;

FIG. 3 is a cross-sectional view of a section position B-B marked in FIG. 1;

FIG. 4 is a schematic diagram of a lens and a sensor in the embodiment of FIG. 1;

FIG. 5 is a schematic three-dimensional exploded diagram of a focus module and

an actuation module according to an embodiment, in which an exemplary example of a housing of the actuation module is displayed;

FIG. 6 is a schematic diagram of a combination state from a perspective of the embodiment of FIG. 5;

FIG. 7 is a schematic diagram of a combination state of a focus module and an actuation module according to another embodiment, in which another exemplary example of a housing of the actuation module is displayed;

FIG. 8 is a three-dimensional cross-sectional view of a positioner fixing a relative position of a focus module and an actuation module according to an embodiment;

FIG. 9 is a three-dimensional cross-sectional view of an image capture device according to another embodiment, in which a focus barrel and a connecting member are displayed to be a linkage, and a section position in this figure is similar to the position A-A in FIG. 1;

FIG. 10 is a schematic three-dimensional diagram of a sensing module according to an embodiment;

FIG. 11 is a schematic three-dimensional diagram of FIG. 6 from another perspective;

FIG. 12 is a schematic three-dimensional diagram of a focus module and an actuation module mounted on a sensing module according to an embodiment;

FIG. 13 is a schematic three-dimensional diagram of a fixed focal module mounted on the embodiment of FIG. 12 according to an embodiment;

FIG. 14 is a schematic three-dimensional diagram of a fixed focal module, a focus module, and an actuation module after a positioning sensor is removed according to an embodiment;

FIG. 15 is a schematic diagram of an electronic device with image capture according to an embodiment;

FIG. 16 is a cross-sectional view of a section position C-C marked in FIG. 15; and

FIG. 17 is a cross-sectional view of an image capture device according to another embodiment.

### DETAILED DESCRIPTION

The technical solutions adopted by the present invention to achieve an intended invention objective are further described below with reference to drawings and embodiments of the present invention. The drawings have been simplified for illustrative purposes only and illustrate the structure or method invention of the present invention by describing relationships between elements and components of the present invention. Therefore, the elements shown in the drawings are not represented in actual quantities, actual shapes, actual sizes, and actual proportions, and dimensions or proportions of dimensions have been exaggerated or simplified. The actual quantities, the actual shapes, or the actual size proportions are selectively designed and configured to provide better illustration, and detailed component layouts may be more complex.

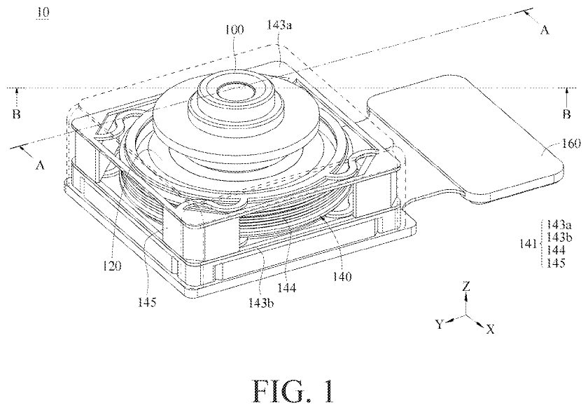

Referring to FIG. 1, FIG. 1 is a three-dimensional perspective view of an image capture device according to an embodiment. An image capture device 10 includes a fixed focal module 100, a focus module 120, an actuation module 140, and a sensing module 160. The fixed focal module 100 is fixed on the actuation module 140, the focus module 120 is located in the actuation module 140, and the sensing module 160 is adjacent to the focus module 120 and the actuation module 140.

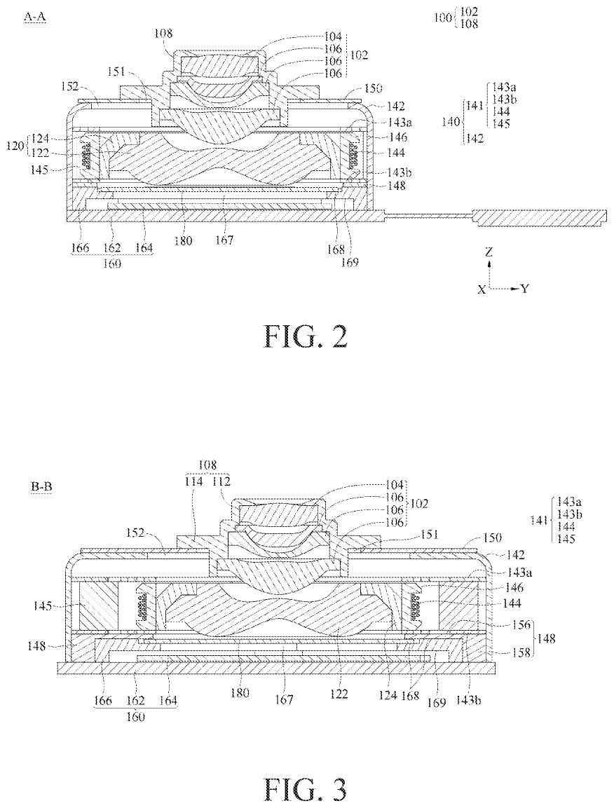

Referring to FIG. 2 and FIG. 3 together, FIG. 2 is a cross-sectional view of a section position A-A marked in FIG. 1, and FIG. 3 is a cross-sectional view of a section position B-B marked in FIG. 1. The fixed focal module 100 includes a fixed lens group 102 and a fixed barrel 108, and the fixed lens group 102 includes a front fixed lens 104 and a plurality of inner fixed lenses 106. The focus module 120 is adjacent to the fixed focal module 100 and includes a focus lens 122.

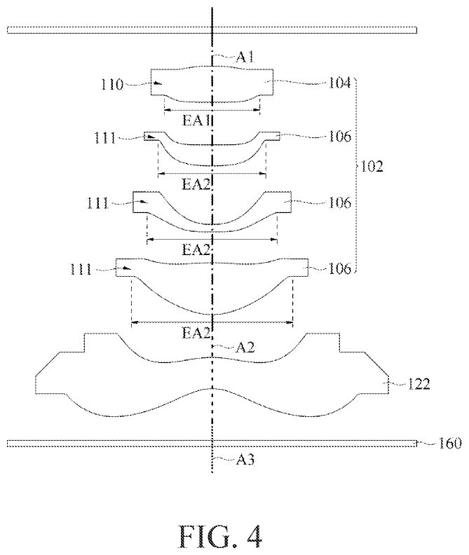

Referring to FIG. 4, FIG. 4 is a schematic diagram of a lens and a sensor in the embodiment of FIG. 1. The front fixed lens 104 and each inner fixed lens 106 have optical effective regions EA1 and EA2 respectively, and the optical effective region EA1 of the front fixed lens 104 is smaller than or equal to the optical effective region EA2 of each inner fixed lens 106. Except that the optical effective region EA1 of the front fixed lens 104 should be the smallest in the fixed lens group 102, a size of the optical effective region EA2 of the inner fixed lens 106 is not limited.

The fixed lens group 102 has a fixed lens group optical axis A1, the focus lens 122 has a focus lens optical axis A2, and the sensing module 160 has a sensing optical axis A3. The focus lens optical axis A2 is aligned with the fixed lens group optical axis A1, and the sensing optical axis A3 is aligned with the fixed lens group optical axis A1 and the focus lens optical axis A2. The actuation module 140 actuates the focus module 120 to move along the focus lens optical axis A2.

In some embodiments, there are three inner fixed lenses 106, and the front fixed lens 104, the inner fixed lens 106, and the focus lens 122 are arranged in sequence in an incident direction of imaging light toward a direction of the sensing module 160. The front fixed lens 104 and the three inner fixed lenses 106 may be optical lenses. Each optical lens has its own optical axis. The optical axes of each lens are substantially aligned with each other to form the fixed lens group optical axis A1 of the fixed lens group 102. The focus lens optical axis A2 is a lens optical axis of the focus lens 122. The sensing optical axis A3 is a center line passing through the sensing module 160. In a case that the fixed lens group optical axis A1, the focus lens optical axis A2, and the sensing optical axis A3 are aligned, imaging light from an object passing through the fixed focal module 100 and the focus module 120 is focused on the sensing module 160, so that the image capture device 10 captures a clear and accurate image.

Referring to FIG. 4, in some embodiments, the front fixed lens 104 and the inner fixed lens 106 include outer ring regions 110 and 111 in addition to the optical effective regions EA1 and EA2. The outer ring regions 110 and 111 are peripheral regions of the optical effective regions EA1 and EA2 on the front fixed lens 104 and the inner fixed lens 106 in which optical effects cannot be effectively provided. A radial length from an edge of the outer ring region 110 to an edge of the optical effective region EA1 is longer than a length from the optical effective region EA1 to the fixed lens group optical axis A1, to ensure that the front fixed lens 104 does not have an excessively large diameter or the diameter complies with the specification but the optical effective region EA1 is too small due to a size of the outer ring region 110, causing the front fixed lens 104 cannot achieve a specific optical property. In some embodiments, a diameter of the front fixed lens 104 is less than or equal to 5 millimeters.

The smaller sizes of the optical effective region EA1 and the outer ring region 110 of the front fixed lens 104 are, a radial size of the fixed barrel 108 can be correspondingly smaller, so that when the image capture device 10 is used in an electronic device, an area of a window of the electronic device corresponding to the image capture device 10 becomes smaller, making it easier to integrate the image capture device 10 into the electronic device. In some embodiments, the sizes of the optical effective region EA1 and the outer ring region 110 may be reduced as much as possible, so in a case that a diameter of the front fixed lens 104 is maintained to be less than or equal to 5 millimeters, the front fixed lens 104 may have a larger size of the optical effective region EA1.

The outer ring region 111 of the inner fixed lens 106 has no size limit, so that the inner fixed lens 106 may be leaned against the fixed barrel 108. The imaging light enters the optical effective regions EA1 and EA2 of the front fixed lens 104 and the inner fixed lens 106, and the outer ring regions 110 and 111 of the lenses may abut against the fixed barrel 108 to fix the front fixed lens 104 and the inner fixed lens 106 on an inner side of the fixed barrel 108 respectively.

Still referring to FIG. 2 and FIG. 3, in some embodiments, the focus module 120 includes a focus barrel 124, and the focus barrel 124 surrounds a periphery of the focus lens 122 to provide support and stability to the focus lens 122.

When the actuation module 140 actuates the focus module 120 to move along the focus lens optical axis A2, in some embodiments, a movable distance of the focus module 120 is 0.06 millimeters, so that a focus range of the image capture device 10 is between infinity and 15 centimeters.

In some embodiments, the actuation module 140 includes an actuator 141, a housing 142, a connecting member 146, and a base 148. The actuator 141, the connecting member 146, and the base 148 are located in the housing 142, where the actuator 141 surrounds and suspends the connecting member 146 and the connecting member 146 is in contact with the focus barrel 124. When the actuator 141 is activated, the connecting member 146 is actuated by the actuator 141 to drive the focus module 120 to move along the focus lens optical axis A2. As described above, that the fixed focal module 100 is fixed on the actuation module 140, and the focus module 120 is located in the actuation module 140 means that the fixed focal module 100 is fixed above the housing 142, the focus module 120 is located in the housing 142, and the focus module 120 is fixed on radial inner sides of the actuator 141 and the connecting member 146.

In some embodiments, the fixed barrel 108 has a barrel body 112 and a protrusion region 114. The protrusion region 114 extends outward from the barrel body 112 to a specific region and forms an annular plane. The barrel body 112 is used to fix the fixed lens group 102 in the fixed barrel 108, and the protrusion region 114 is used to fit with the housing 142, so that the fixed focal module 100 is fixed above the housing 142.

In some embodiments, the actuation module 140 is implemented by a voice coil motor (VCM), a servo motor, a piezo motor, or a shape memory alloy motor.

Still referring to FIG. 1 or FIG. 3, taking the voice coil motor as an example, in some embodiments, a magnetic yoke responsible for protecting and fixing a voice coil motor component may be used as the housing 142, and a base of the voice coil motor for fixing and supporting the motor component may be used as the base 148. A bracket fixed in the yoke is used as the connecting member 146, and an upper elastic member 143a, a lower elastic member 143b, a coil 144, and a magnet 145 of the voice coil motor are used as the actuator 141. The upper elastic member 143a and the lower elastic member 143b may respectively include an inner ring and an outer ring. The inner ring suspends the connecting member 146 and stabilizes the connecting member 146, and the outer ring is fixed to the base 148 and the magnet 145.

The magnet 145 provides a magnetic field. When the coil 144 is energized, the coil 144 and the magnet 145 generate electromagnetic induction, thereby enabling the upper elastic member 143a and the lower elastic member 143b to pull or push the connecting member 146 to move. Specifically, when the coil 144 is energized, the magnetic field generated by a current interacts with the magnet 145, causing the magnet 145 to generate a magnetic force. The magnetic force may generate a force between the magnet 145 and the coil 144, thereby causing movement. In this case, the housing 142 may be used to guide and enhance the magnetic field, and provide a magnetic path through the housing 142, so that the magnetic force may be transmitted to the magnet 145 more effectively. Therefore, the electromagnetic induction generated after the coil is energized mainly acts on the magnet, and the yoke plays a role of enhancing and guiding the magnetic field. Therefore, the movement of the voice coil motor may be controlled by controlling a magnitude and a direction of the current in the coil 144, so that the actuation module 140 drives the focus module 120 to move forward and backward along the focus lens optical axis A2, to adjust a focal length or a zoom effect of the image capture device 10.

When the upper elastic member 143a, the lower elastic member 143b, the magnet 145, the connecting member 146, and the base 148 are integrated, an adhesive may be used for fixing. The coil 144 is wound on a radial outer side of the connecting member 146, and then the housing 142 is covered to fix the entire actuation module 140. In addition to the foregoing structure, voice coil motors of other structures may also be used to realize the movement of the focus module 120.

In some embodiments, in addition to actuating the focus module 120 to move along a direction of the focus lens optical axis A2 (refer to a Z-axis shown in FIG. 2) to adjust the focal length of the image capture device 10, the actuator 141 may also actuate the connecting member 146 to cause the connecting member 146 to drive the focus module 120 to undergo a corresponding movement in a direction perpendicular to the focus lens optical axis A2 (refer to an X-axis and a Y-axis shown in FIG. 2). A user may cause vibration when using the image capture device 10. For example, a hand shake of the user causes the focus lens optical axis A2 and a center of the imaging light entering the image capture device 10 to be tilted, causing image blur. The actuator 141 may realign the focus lens optical axis A2 to the center of the imaging light by moving the focus module 120. For example, the actuator 141 generates a movement corresponding to a direction and a distance of the hand shake of the user, thereby counteracting the hand shake to achieve hand shake compensation.

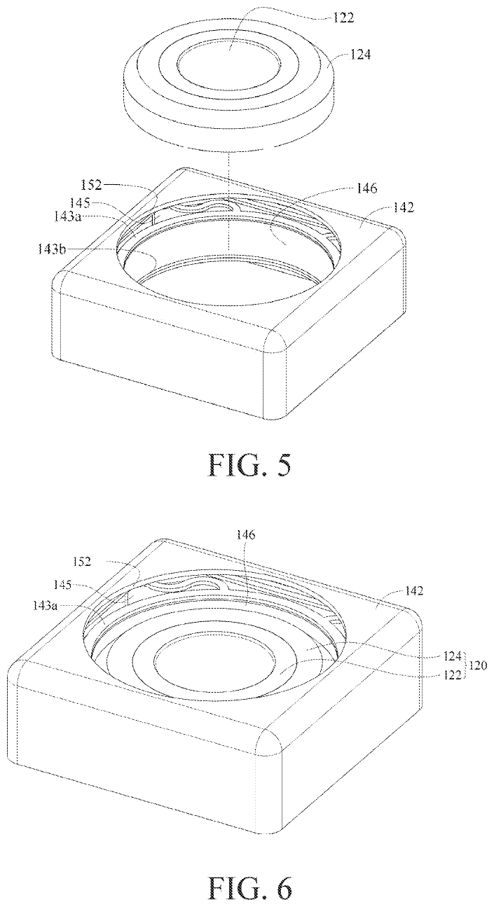

Referring to FIG. 3 and FIG. 5, FIG. 5 is a schematic three-dimensional exploded diagram of a focus module and an actuation module according to an embodiment, in which an exemplary example of a housing of the actuation module is displayed. In some embodiments, the housing 142 has a window 152, and the window 152 corresponds to a contact region between the connecting member 146 and the focus barrel 124. “Corresponding” means that a size of the window 152 is equal to or slightly greater than a size of the contact region between the focus barrel 124 and the connecting member 146. When the focus module 120 is placed into the housing 142, the focus module 120 may be placed through the window 152 (after the focus module 120 is placed into the housing 142, as shown in FIG. 6). Compared with placing the focus module 120 into the housing 142 from the bottom of the housing 142, placing the focus module 120 into the housing 142 from the window 152 may achieve better process accuracy. After insertion, the adhesive may be applied with an adhesive needle in a dispensing method from the window 152 to the annular region in which the focus barrel 124 is in contact with the connecting member 146 to fix the focus module 120 on the connecting member 146. In this way, when the connecting member 146 is actuated by the actuator 141, the connecting member 146 may drive the focus barrel 124 to move together.

Still referring to FIG. 3, in some embodiments, since a diameter of the window 152 may be designed to be greater than a diameter of the protrusion region 114 of the fixed barrel 108, the protrusion region 114 cannot be leaned against and fixed on the housing 142. Therefore, a covering layer 150 may be provided, and the protrusion region 114 is leaned against and fixed on the covering layer 150. The covering layer 150 has a circular opening 151 (also refer to FIG. 12). A center of the opening 151 corresponds to the center of the window 152. A size of the opening 151 is slightly greater than a size of the barrel body 112 of the fixed barrel 108, so that there is a gap between an edge of the opening 151 of the covering layer 150 and the barrel body 112, but the edge of the opening 151 does not exceed a radial outermost side of the protrusion region 114.

For example, if a diameter of the barrel body 112 of the fixed barrel 108 is 3.6 millimeters, and the protrusion region 114 extends 0.7 millimeters outward from the barrel body 112, then a diameter of the opening 151 of the covering layer 150 may be 4.2 millimeters, so that the gap between the opening 151 and the barrel body 112 may be kept at 0.3 millimeters, the protrusion region 114 may be leaned against the covering layer 150, and a range used for fixing is still 0.4 millimeters. The fixed focal module 100 may be fixed on the housing 142 through the covering layer 150, and a plane provided by the covering layer 150 may increase the stability of the fixed focal module 100 on the housing 142.

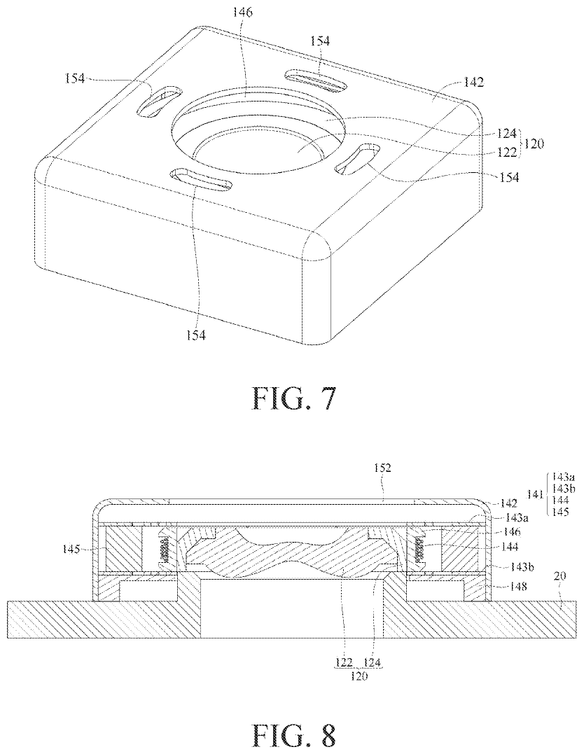

Referring to FIG. 7, FIG. 7 is a schematic diagram of a combination state of a focus module and an actuation module according to another embodiment, in which another exemplary example of a housing of the actuation module is displayed. In some embodiments, the housing 142 has an opening 154, and the opening 154 corresponds to part of the contact region between the connecting member 146 and the focus barrel 124. The opening 154 may be used for inserting an adhesive dispensing needle during assembly at the contact region between the connecting member 146 and the focus barrel 124, so that the focus barrel 124 is fixed to the connecting member 146. Therefore, a quantity and positions of the openings 154 correspond to a quantity of part of the contact regions. A size of the opening 154 should be greater than the dispensing needle, and a length (arc length) of the opening 154 should be longer than an arc length of desired dispensing. The foregoing part of the contact region may be one or more regions on a contact ring between the connecting member 146 and the focus barrel 124. A range size or a position of the region is sufficient to support a stable and a fixed range between the connecting member 146 and the focus barrel 124. For example, there are four contact regions, and the four contact regions are respectively located at point-symmetric or line-symmetric positions on a ring at which the connecting member 146 is in contact with the focus barrel 124. There are four openings 154 corresponding to the contact regions, and are provided on the housing 142 at positions corresponding to the contact regions, and are located at positions 90 degrees apart on the housing 142 (viewed from a top view of FIG. 7).

Based on a size and a position of the opening 154, when the fixed barrel 108 is leaned against and fixed on the housing 142, it is less likely that the diameter of the window 152 is designed to be greater than the diameter of the protrusion region 114 of the fixed barrel 108, so that the protrusion region 114 cannot be leaned against and fixed on the housing 142. Therefore, the covering layer 150 may not be arranged between the housing 142 and the fixed barrel 108.

Referring to FIG. 8, FIG. 8 is a three-dimensional cross-sectional view of a positioner fixing a relative position of a focus module and an actuation module. In some embodiments, to control the focus module 120 to be accurately fixed in the actuation module 140, a high-precision positioner 20 may be placed under the focus module 120, so that the focus module 120 is leaned against the positioner 20, to fix the relative position of the focus module 120 and the actuation module 140. In addition, when the focus module 120 is leaned against the positioner 20, the adhesive between the focus barrel 124 and the connecting member 146 is solidified, so that the relative position of the focus module 120 and the actuation module 140 remains unchanged when the adhesive is solidified.

In some embodiments, the adhesive used to fix the focus module 120 and the actuation module 140 is UV adhesive, or thermal adhesive, or other mixed adhesive.

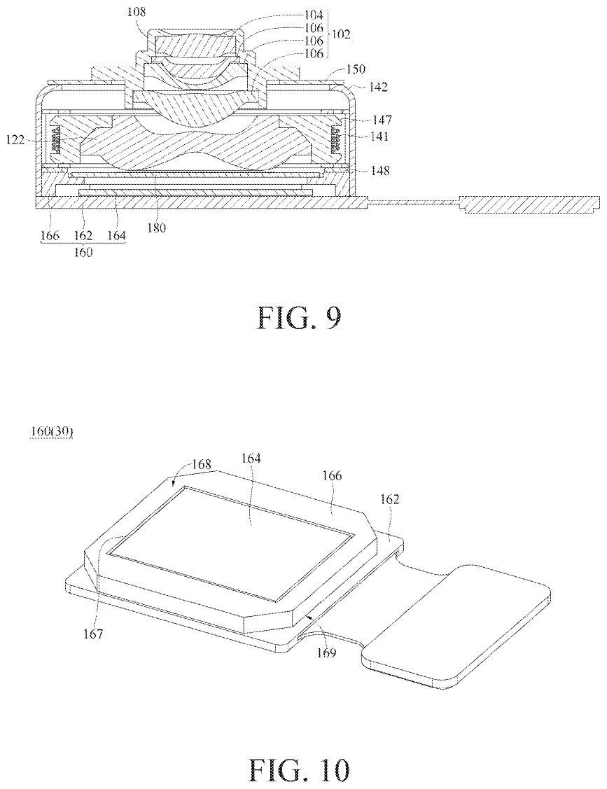

Referring to FIG. 9, FIG. 9 is a three-dimensional cross-sectional view of an image capture device according to another embodiment, in which a focus barrel and a connecting member are displayed to be a linkage. In some embodiments, the focus barrel 124 and the connecting member 146 are used as a linkage 147. The linkage 147 may be integrally formed. A radial inner side of the linkage 147 is in contact with the focus lens 122 and provides support for the focus lens 122. A radial outer side of the linkage 147 surrounds the actuator 141, and the actuator 141 actuates to push the linkage 147 to move, so that the focus lens 122 moves forward and backward along the direction of the focus lens optical axis A2 to adjust the focus. In a case that the linkage 147 is integrally formed, when the actuator 141 actuates the focus lens 122 to move, a quantity of connection points between components is reduced, thereby reducing movement losses and other unstable factors caused by friction, vibration, and structural looseness, which can adjust the focus more accurately. In addition, the focus barrel 124 and the connecting member 146 are integrally formed into the linkage 147, which can reduce the overall size of the actuation module 140 and reduce a volume of the image capture device 10. In addition, without changing the overall size of the actuation module 140, that is, the size of the housing 142 is maintained, the integrated molding of the linkage 147 may also increase a usable space in the housing 142, so that the actuator 141 has a larger volume (for example, more coil turns around it), thereby increasing the electromagnetic efficiency of the actuator 141.

Still referring to FIG. 3 and referring to FIG. 10, FIG. 10 is a schematic three-dimensional diagram of a sensing module according to an embodiment. In some embodiments, the sensing module 160 includes a circuit board 162, a sensor 164, and a holder 166. The sensor 164 and the holder 166 are located on the circuit board 162, the sensor 164 is electrically connected to the circuit board 162, and the holder 166 covers the sensor 164. The sensing optical axis A3 is an optical axis of the sensor 164, that is, a center of the light when the imaging light enters the sensor 164. The sensing optical axis A3 is substantially aligned with the fixed lens group optical axis A1 and the focus lens optical axis A2, so that the sensing optical axis A3, the fixed lens group optical axis A1, and the focus lens optical axis A2 approach a straight line.

In some embodiments, the sensor 164 may be a photosensitive device converting photons into electronic signals, such as a CMOS (Complementary Metal-Oxide-Semiconductor) photoreceptor, a CCD (Charge-Coupled Device) photoreceptor, a BSI (Back Side Illuminated) photoreceptor, or the like.

In some embodiments, the holder 166 is adjacent to the base 148, and the holder 166 has a penetration region 167, an upper surface 168, and a lower surface 169. The penetration region 167 allows the imaging light to run through, and a range of the penetration region 167 corresponds to the focus lens 122 and the sensor 164, so that the sensor 164 can completely receive the imaging light that runs through the fixed lens group 102 and the focus lens 122. The upper surface 168 faces a direction of the connecting member 146 and the actuator 141, and a portion of the base 148 fits with the upper surface 168. In some embodiments, the upper surface 168 carries a lens 180. The lens 180 may be, but is not limited to, a filter, a polarizer, a subtractive lens, a bokeh lens, and the like. The lower surface 169 faces the sensor 164 and completely covers the sensor 164. The holder 166 may protect the sensor 164 and provide a function of preventing dust.

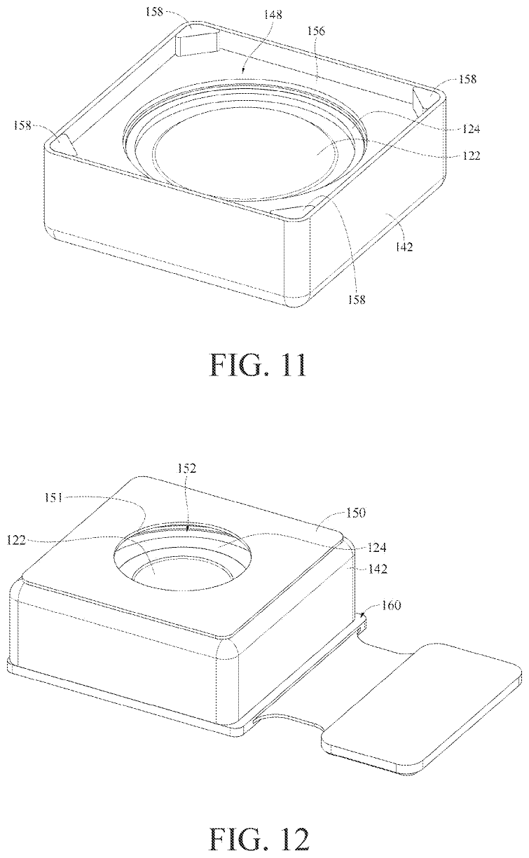

In some embodiments, four corners of the holder 166 are chamfered (chamfering of four sides of the holder 166 in FIG. 10), and the space allowed allows part of the base 148 to stand on the circuit board 162. Specifically, referring to FIG. 11, FIG. 11 is a schematic three-dimensional diagram of FIG. 6 from another perspective. The base 148 includes a platform 156 and a plurality of supporting portions 158. The supporting portions 158 are located at four corners of the base 148 and generate supporting legs in a direction from the platform 156 toward the circuit board 162. The platform 156 of the base 148 is located on the holder 166, and the supporting portion 158 is located in the space avoided by the four corners of the holder 166, passing through the holder 166 and leaned against the circuit board 162. The platform 156 of the base 148 is located on the holder 166, and the supporting portion 158 of the base 148 is directly leaned against the circuit board 162, which can increase parallelism between the focus module 120 and the sensing module 160, and the fixed lens group optical axis A1, the focus lens optical axis A2, and the sensing optical axis A3 can continue to maintain a state of approaching a straight line after alignment. In some embodiments, colloid is used to fill a gap between the base 148 and the holder 166, so that there is no gap at which the base 148 and the holder 166 fit together, which can further prevent dust from entering the sensing module 160 from the actuation module 140.

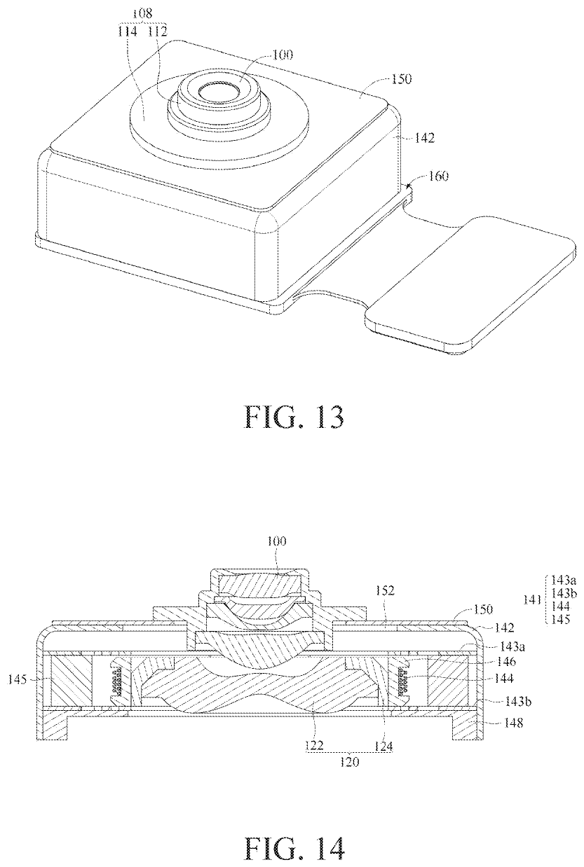

Referring to FIG. 12 and FIG. 13, FIG. 12 is a schematic three-dimensional diagram of a focus module and an actuation module mounted on a sensing module according to an embodiment, and FIG. 13 is a schematic three-dimensional diagram of a fixed focal module mounted on the embodiment of FIG. 12 according to an embodiment. In some embodiments, after the focus module 120 is mounted into the actuation module 140, the actuation module 140 may be mounted on the sensing module 160 first, and then the fixed focal module 100 and the focus module 120 may be aligned and fixed, that is, in the fixed focal module 100, the protrusion region 114 of the fixed barrel 108 is coated with the adhesive, the focus lens optical axis A2 is substantially aligned with the fixed lens group optical axis A1 in an optical active alignment manner, after the adhesive is solidified, the protrusion region 114 fits with the housing 142 of the actuation module 140 or the covering layer 150, and the barrel body 112 fixes the fixed lens group 102 and located at the window 152 of the housing 142.

In some embodiments, in order to achieve a better alignment effect between the fixed lens group optical axis A1 and the focus lens optical axis A2, or in a case that sensitivities of the fixed lens group 102 and the focus lens 122 are high, when the actuation module 140 is mounted on the sensing module 160, a positioning sensor 30 is used to replace the sensing module 160. The positioning sensor 30 is basically the same as the sensing module 160. The difference is that the positioning sensor 30 has higher precision and accuracy. When the position and the direction of the lens are fixed, better alignment of the fixed lens group optical axis A1 and the focus lens optical axis A2 can be achieved.

If the positioning sensor 30 is used to replace the sensing module 160 when the fixed focal module 100 and the focus module 120 are aligned in the optical active alignment manner, then the positioning sensor 30 is removed after the fixed focal module 100 and the focus module 120 are aligned and fixed with the solidified adhesive (as shown in FIG. 14). Subsequently, the sensing optical axis A3 is substantially aligned with the fixed lens group optical axis A1 and the focus lens optical axis A2 in the optical active alignment manner again.

In some embodiments, the image capture device 10 has a field of view (FOV). The field of view is between 90 degrees and 100 degrees, indicating that an angle of the imaging light that the image capture device 10 can capture is between 90 degrees and 100 degrees. Table 1 is reference data of the image capture device 10 with a field of view of 100 degrees.

TABLE 1

| Project | Numerical value | |
|---|---|---|
| Sensor size | 1/3″ | |
| Lens structure | 5 lenses in total | |
| Total track length (TTL) | 4.0 | mm |
| Total track length/Image height (TTL/Image Height) | 1.36 | |
| Stroke for Macro (15 cm) | 60 | micrometers |

| | |
|---|---|
| Chief ray angle (CRA) | 37.5° |

The lens structure may include the fixed lens group 102 in the fixed focal module 100 and the focus lens 122 in the focus module 120. The fixed lens group 102 includes the front fixed lens 104 and three inner fixed lenses 106, and the focus lens 122 is one piece, forming a total of 5 lenses. A total length of the lens, that is, a distance between a surface of the front fixed lens 104 facing the object and the sensor 164, may be 4 millimeters, so that the image capture device 10 may be integrated into the electronic device, where when the focus module 120 moves 60 micrometers, the focal length of the image capture device 10 may be adjusted from infinity to 15 centimeters. A ratio of the total track length to the image height can reflect miniaturization and lightweight of the image capture device 10 while ensuring that the image capture device 10 can have a certain level of performance and image quality. The chief ray angle of a side of the focus lens 122 facing the sensor 164 may be 37.5 degrees, so that the focus lens 122 and the sensor 164 are matched to avoid problems such as Luma shading and color shading, contrast reduction, and color cast when the image capture device 10 is used.

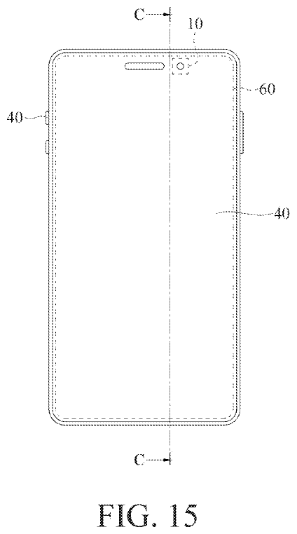

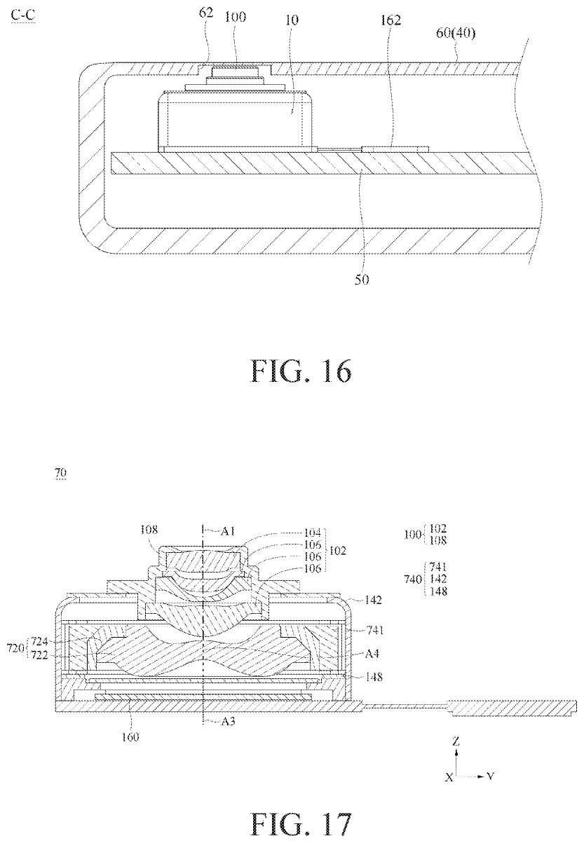

Referring to FIG. 15 and FIG. 16 together, FIG. 15 is a schematic diagram of an electronic device with image capture according to an embodiment, and FIG. 16 is a cross-sectional view of a section position C-C marked in FIG. 15. The electronic device with image capture includes an input interface 40, an image capture device 10, a main board 50, and a display 60. The input interface 40 is configured to receive an input instruction from the user.

The image capture device 10 is connected to the input interface 40. Still referring to FIG. 2, the image capture device 10 includes a fixed focal module 100, a focus module 120, an actuation module 140, and a sensing module 160. The fixed focal module 100 is as described above, where the fixed lens group optical axis A1 corresponds to a target object. The focus module 120 is adjacent to the fixed focal module 100. The fixed focal module 100 is fixed on the actuation module 140. The focus module 120 is located in the actuation module 140. The actuation module 140 actuates the focus module 120 to move along the focus lens optical axis A2 to change the focal length of the image capture device 10.

The sensing module 160 has a sensing optical axis A3. The sensing optical axis A3 is aligned with the fixed lens group optical axis A1 and the focus lens optical axis A2. The imaging light of the target object enters from the fixed focal module 100 and the focus module 120 and is focused on the sensing module to form an image of the target object on the sensing module 160. The sensing module 160 captures the imaging light of the target object according to the input instruction and converts the image of the target object into an image signal.

The main board 50 is connected to the sensing module 160 of the image capture device 10. Specifically, the circuit board 162 of the sensing module 160 is electrically connected to the main board 50 and can obtain power from the main board 50 to actuate the actuation module 140. The sensing module 160 transmits the image signal to the main board 50 and the image signal is received by the main board 50. In some embodiments, after the image signal is received, the main board 50 performs operations such as noise reduction, sharpening, contrast adjustment, and white balance calibration on the image signal. The display 60 is connected to the main board 50. The processed or unprocessed image signal is output from the main board 50 to the display 60. The display 60 displays the image of the target object according to the image signal.

The display 60 has a translucent region 62. The translucent region 62 is a windowed region on the display 60 for the light to enter the image capture device 10. The front fixed lens 104 is located in the translucent region 62. A size of the translucent region 62 corresponds to the optical effective region EA1 of the front fixed lens 104 and the fixed barrel 108. In some embodiments, the translucent region 62 needs to be larger than the optical effective region EA1, so that the display 60 does not block the imaging light from entering the image capture device 10. Since the front fixed lens 104 is close to an outer surface of the display 60, the opening window of the translucent region 62 needs to correspond to an outer diameter of the fixed barrel 108. In addition, when the front fixed lens 104 has an outer ring region 110, the smaller a size of the outer ring region 110, a radial size of the fixed barrel 108 may be correspondingly smaller, thereby reducing a size of the opening window on the display 60. There is a gap between an edge of the translucent region 62 and the fixed barrel 108 outside the front fixed lens 104. In some embodiments, a size of the gap is mainly to avoid interference between the display 60 and the fixed barrel 108, for example, may be 0.2 millimeters. Therefore, the size of the opening window on the display 60 may be within a specific size to avoid the translucent region 62 from affecting a display range of the display 60.

In some embodiments, the image capture device 10 is used as a front-facing lens of the electronic device. The display 60 may be, but is not limited to, a touch screen or a general display screen (that is, it does not have a touch function). When the display 60 is the touch screen, the input interface 40 may be the display 60, or the input interface 40 may be a combination of one or more buttons on the electronic device. The electronic device may be implemented by a mobile phone, a tablet computer, and the like.

Referring to FIG. 17, FIG. 17 is a cross-sectional view of an image capture device according to another embodiment. An apparatus integrated into the electronic device with image capture may also include a fixed focal module 100, a moving module 720, an anti-shake module 740, and a sensing module 160 of an image capture device 70. The fixed focal module 100 includes a fixed lens group 102 and a fixed barrel 108. The fixed lens group 102 includes a front fixed lens 104 and a plurality of inner fixed lenses 106. The fixed barrel 108 fixes the front fixed lens 104 and each inner fixed lens 106.

Still referring to FIG. 4, the front fixed lens 104 and each inner fixed lens 106 have optical effective regions EA1 and EA2 respectively. The optical effective region EA1 of the front fixed lens 104 is smaller than or equal to the optical effective region EA2 of each inner fixed lens 106. In some embodiments, since the optical effective region EA1 of the front fixed lens 104 is smaller, a diameter of the front fixed lens 104 is also less than a diameter of each inner fixed lens 106. Therefore, with the smaller diameter, when the image capture device 70 is integrated into the electronic device, the opening window at a position of the electronic device corresponding to the image capture device 70 may be smaller. Each lens of the fixed lens group 102 has its own optical axis, and these optical axes are aligned with each other to form the fixed lens group optical axis A1.

The moving module 720 is adjacent to the fixed focal module 100 and includes a moving lens 722, and the moving lens 722 has a moving lens optical axis A4. In some embodiments, the moving lens 722 moves in a direction perpendicular to the fixed lens group optical axis A1 (refer to the X-axis and Y-axis shown in FIG. 17) to perform anti-shake compensation for the perceived shake of the image capture device 70. The moving module 720 may be equivalent to the foregoing focus module 120 and include a moving barrel 724 fixing the moving lens 722.

Movement of the moving lens 722 is actuated by the anti-shake module 740. The fixed focal module 100 is fixed to the anti-shake module 740, and the moving module 720 is located in the anti-shake module 740. The anti-shake module 740 is configured to actuate the moving module 720 to generate corresponding movement on a plane perpendicular to the fixed lens group optical axis A1 to align the moving lens optical axis A4 and the fixed lens group optical axis A1 with a center of the imaging light of the target object. The sensing module 160 has a sensing optical axis A3, and the sensing optical axis A3 is aligned with the fixed lens group optical axis A1. The sensing module 160 is configured to receive the light passing through the fixed focal module 100 and the moving module 720.

The shaking of the image capture device 70 is caused by the hand shake caused by the user as mentioned above. When the hand shake occurs, the fixed lens group optical axis A1 and the moving lens optical axis A4 are tilt relative to the center of the image (that is, the center of the imaging light incident on the sensing module 160) due to the hand shake, thereby affecting the imaging quality. A movement direction and a movement distance generated by the anti-shake module 740 by actuating the moving module 720 are opposite to a movement direction and a movement distance of the hand shake, thereby realigning the fixed lens group optical axis A1 and the focus lens optical axis A2 to the center of the imaging light to achieve hand shake compensation and maintain imaging clarity and stability of capturing an image.

In some embodiments, a manner in which the anti-shake module 740 actuates the moving module 720 to move may refer to the manner in which the actuation module 140 actuates the focus module 120 described above. For example, the anti-shake module 740 may include a shock absorber 741, a housing 142, and a base 148. The shock absorber 741 and the base 148 are located in the housing 142. The shock absorber 741 surrounds the moving barrel 724 and is in contact with the moving barrel 724. When the shock absorber 741 is activated, the moving barrel 724 is actuated by the shock absorber 741 and connected to the moving lens 722, and moves in a direction perpendicular to the fixed lens group optical axis A1.

In some embodiments, the anti-shake module 740 is implemented by a voice coil motor, a ball type motor, a piezoelectric motor, or a shape memory alloy motor.

In conclusion, even if the image capture device 10 has a function of adjusting the focal length and/or anti-shake, when the image capture device 10 is integrated into the electronic device, the diameter of the front fixed lens 104 and a range of the optical effective region EA1 in the fixed lens group 102 are smaller than those of the inner fixed lens 106, so the electronic device may need the opening window to allow the range of the imaging light entering the image capture device 10 to be smaller.

The foregoing are only embodiments of the present invention, but does not limit the present invention in any form. The embodiments are already used to disclose the present invention above, but are not used to limit the present invention. Without going beyond a scope of technical solutions of the present invention, any person who has general knowledge in the art may make some variations or modifications to the technical content disclosed above, to obtain equivalent embodiments with equivalent changes. However, any simple alteration, equivalent change, or modification made to the foregoing embodiments based on technical essence of the present invention without disobeying content of the technical solutions of the present invention still falls within the scope of the technical solutions of the present invention.

What is claimed is:

1. An image capture device, comprising:
a fixed focal module, comprising a fixed lens group and a fixed barrel, the fixed lens group comprising a front fixed lens and a plurality of inner fixed lenses, the fixed barrel fixing the front fixed lens and the plurality of inner fixed lenses, the front fixed lens and the inner fixed lenses each having an optical effective region, the optical effective region of the front fixed lens being smaller than or equal to the optical effective region of each inner fixed lens, and the fixed lens group having a fixed lens group optical axis;
a focus module, adjacent to the fixed focal module and comprising a focus lens, the focus lens having a focus lens optical axis, and the focus lens optical axis being aligned with the fixed lens group optical axis;
an actuation module, the fixed focal module being fixed on the actuation module, the focus module being located in the actuation module, and the actuation module being configured to actuate the focus module to move along the focus lens optical axis; and
a sensing module, having a sensing optical axis, the sensing optical axis being aligned with the fixed lens group optical axis and the focus lens optical axis.

2. The image capture device according to claim 1, wherein the actuation module further comprises a housing, an actuator, a connecting member, and a base, the actuator, the connecting member, and the base are located in the housing, the base supports the connecting member, the actuator surrounds the connecting member and the connecting member is in contact with the focus module to enable the actuator to actuate the connecting member, the connecting member moves the focus module along the focus lens optical axis, the housing has a window, and the fixed barrel is fixed to the window.

3. The image capture device according to claim 2, wherein the focus module comprises a focus barrel, the focus barrel fixes the focus lens, the window corresponds to a contact region between the connecting member and the focus barrel, the actuation module comprises a covering layer, the covering layer is located above the window, and the fixed barrel is located on the covering layer.

4. The image capture device according to claim 3, wherein the housing further comprises an opening, and the opening corresponds to part of the contact region between the connecting member and the focus barrel.

5. The image capture device according to claim 2, wherein the sensing module comprises a circuit board, a sensor, and a holder, the sensor and the holder are located on the circuit board, and the holder covers the sensor.

6. The image capture device according to claim 5, wherein the base comprises a platform and a plurality of supporting portions, the platform is located on the holder, and the supporting portions are leaned against the circuit board through the holder.

7. The image capture device according to claim 5, further comprising a lens, the lens being located on the holder.

8. The image capture device according to claim 2, wherein the focus module further comprises a focus barrel, and the focus barrel fixes the focus lens.

9. The image capture device according to claim 8, wherein the focus barrel and the connecting member are constructed as a linkage.

10. The image capture device according to claim 1, wherein the focus module is located in the actuation module, and a positioner fixes a relative position of the focus module and the actuation module.

11. The image capture device according to claim 1, wherein the focus lens optical axis is aligned with the fixed lens group optical axis in an optical active alignment manner, and the sensing optical axis is aligned with the fixed lens group optical axis and the focus lens optical axis in the optical active alignment manner.

12. The image capture device according to claim 11, wherein alignment of the focus lens optical axis with the fixed lens group optical axis in the optical active alignment manner is performed by a positioning sensor.

13. The image capture device according to claim 1, wherein the actuation module is further configured to actuate the focus module to generate corresponding movement on a plane perpendicular to the focus lens optical axis to offset hand shake.

14. The image capture device according to claim 1, wherein the image capture device has a focus range, and the focus range is between infinity and 15 centimeters.

15. The image capture device according to claim 1, wherein the image capture device has a field of view, and the field of view is between 90 degrees and 100 degrees.

16. An electronic device with image capture, comprising:
an input interface, configured to receive an input instruction;
an image capture device, connected to the input interface, the image capture device comprising:
a fixed focal module, comprising a fixed lens group and a fixed barrel, the fixed barrel fixing the fixed lens group, the fixed lens group comprising a front fixed lens and a plurality of inner fixed lenses, the fixed barrel fixing the front fixed lens and the plurality of inner fixed lenses, the front fixed lens and the inner fixed lenses each having an optical effective region, the optical effective region of the front fixed lens being smaller than or equal to the optical effective region of each inner fixed lens, the fixed lens group having a fixed lens group optical axis, and the fixed lens group optical axis corresponding to a target object;
a focus module, adjacent to the fixed focal module and comprising a focus lens, the focus lens having a focus lens optical axis, and the focus lens optical axis being aligned with the fixed lens group optical axis;
an actuation module, the fixed focal module being fixed on the actuation module, the focus module being located in the actuation module, and the actuation module being configured to actuate the focus module to move along the focus lens optical axis; and
a sensing module, having a sensing optical axis, the sensing optical axis being aligned with the fixed lens group optical axis and the focus lens optical axis, and the sensing module being configured to capture the target object according to the input instruction and convert an image of the target object into an image signal;
a main board, connected to the image capture device, the main board receiving the image signal from the image capture device; and
a display, connected to the main board, the display having a translucent region, the front fixed lens being located in the translucent region, and the display receiving the image signal through the main board and then displaying an image according to the image signal.

17. The electronic device with image capture according to claim 16, wherein the actuation module is further configured to actuate the focus module to generate corresponding movement on a plane perpendicular to the focus lens optical axis to offset hand shake.

18. An image capture device, comprising:
a fixed focal module, comprising a fixed lens group and a fixed barrel, the fixed lens group comprising a front fixed lens and a plurality of inner fixed lenses, the fixed barrel fixing the front fixed lens and the plurality of inner fixed lenses, the front fixed lens and the inner fixed lenses each having an optical effective region, the optical effective region of the front fixed lens being smaller than or equal to the optical effective region of each inner fixed lens, and the fixed lens group having a fixed lens group optical axis;
a moving module, adjacent to the fixed focal module and comprising a moving lens, the moving lens having a moving lens optical axis, and the moving lens optical axis being aligned with the fixed lens group optical axis;
an anti-shake module, the fixed focal module being fixed on the anti-shake module, the moving module being located in the anti-shake module, the anti-shake module being configured to actuate the moving module to generate corresponding movement on a plane perpendicular to the fixed lens group optical axis to align the moving lens optical axis and the fixed lens group optical axis with a center of imaging light; and
a sensing module, having a sensing optical axis, the sensing optical axis being aligned with the fixed lens group optical axis.
